(19) United States
(12) Patent Application Publication
(10) Pub. No.: US 2015/0326346 A1
(43) Pub. Date: Nov. 12, 2015

(54) SYSTEM AND METHOD FOR SETTING DOWNSTREAM FORWARD ERROR CORRECTION CODE IN TIME DIVISION MULTIPLEXING PASSIVE OPTICAL NETWORK

(71) Applicant: Electronics and Telecommunications Research Institute, Daejeon (KR)

(72) Inventors: Hark YOO, Gwangju (KR); Dong Soo LEE, Seongnam-si (KR); Hee Do KIM, Gwangju (KR)

(21) Appl. No.: 14/316,867

(22) Filed: Jun. 27, 2014

(30) Foreign Application Priority Data
Feb. 3, 2014 (KR) 10-2014-0012188

(51) Int. Cl. H04L 1/00; H04Q 11/00

(52) U.S. Cl. CPC H04L 1/0027; H04Q 11/0067; H04L 1/0075; H04Q 2011/0033; H04Q 2011/0045

(57) ABSTRACT

Provided are a system and method for setting a downstream forward error correction code for a downstream frame which is transmitted from an optical line terminal to an optical network unit in a time division multiplexing passive optical network. A system for setting a downstream forward error correction code in a time division multiplexing passive optical network includes: an optical line terminal configured to change a downstream forward error correction (FEC) indication included in a downstream frame and set a downstream FEC indication counter included in the downstream frame to transmit the downstream frame; and an optical network unit configured to receive the downstream frame from the optical line terminal and synchronize an FEC setting of the optical network unit with the FEC setting of the optical line terminal as a result of detection of the downstream FEC indication and downstream FEC indication counter included in the downstream frame.

### CROSS-REFERENCE TO RELATED APPLICATIONS

This application claims priority under 35 U.S.C. §119 to Korean Patent Application No. 10-2014-0012188, filed on Feb. 3, 2014, the disclosure of which is incorporated herein by reference in its entirety.

### TECHNICAL FIELD

The present invention relates to a system and method for setting a forward error correction code for a downstream frame which is transmitted from an optical line terminal to an optical network unit in a time division multiplexing passive optical network.

### BACKGROUND

As the number of Internet users are dramatically increased and application services that need broadband are introduced, data traffic increases exponentially and a backbone network expands toward optical-based terabit levels.

Optical access network technology is devised to efficiently provide a necessary bandwidth to a subscriber side and configured to have a point-to-point architecture and a point-to-multipoint architecture.

The optical line terminal (OLT) has an interface for supporting multiple optical network units (ONUs) and has the control authority for all optical network units connected with the optical line terminal.

In general, the point-to-point architecture is applied to an active optical network (AON).

The point-to-multipoint architecture is applied to a passive optical network (PON) and is being standardized by international standardization organizations such as the Institute of Electrical and Electronics Engineers (IEEE) and International Telecommunications Union-Telecom (ITU-T).

The passive optical network (PON) according to the related art has a tree structure configured with an optical line terminal and multiple optical network units in a ratio of 1:N through a passive device.

For downstream transmission from the OLT to the ONU, since data transmitted from the OLT is broadcast to all ONUs, a problem due to medium sharing does not occur.

However, since ONUs are connected to the OLT from a passive device through one optical fiber, a Time Division Multiple Access Medium Access Control (TDMA MAC) protocol is required which can prevent a time overlap and allow simultaneous access to medium in order for upstream transmission without collision between the ONUs.

A forward error correction (FEC) technology has been applied a related art wired/wireless transmission field and recording device, with a function for correcting an error in the transmission medium.

Such a FEC technology is also applied to the passive optical network (PON) technology with higher speed.

In the GPON standard of the ITU-T, forward error correction technology is applied using a Reed-Solomon code (R-S code) (255, 239).

In the XG-PON standard, which is 10G passive optical network technology, Reed-Solomon code (248, 216) is used for downstream transmission and Reed-Solomon code (248, 232) is used for upstream transmission.

In the forward error correction technology in the passive optical network, a rule of whether to apply the forward error correction technology varies depending on technical standards of the passive optical network according to an application range of the standard and main service requirements.

The GPON defines that for upstream transmission, the FEC setting may be changed for each ONU burst that is transmitted upstream in order to expand an upstream bandwidth for an ONU located near the OLT.

And the GPON defines that for downstream transmission, the FEC setting may be equally applied to all ONUs because of characteristics of the passive optical network having a point-to-multipoint structure.

The determination of whether to apply the downstream FEC is delivered for each frame through an FEC identifier located in a downstream frame header, and the ONU changes the setting of FEC according to the setting by the FEC identifier when receiving FEC identifiers that are different from an existing value through four frames consecutively, in order to preparing for a bit error that may reside in the FEC identifier.

Accordingly, a timing for changing the FEC setting may vary depending on whether to receive the FEC identifier successfully, thus generating a temporary loss of downstream traffic.

In considering the problem, the GPON standard does not assume the change of the downstream FEC setting during the operation of the ONU and refers that the change of the downstream FEC setting may lead to a temporary traffic loss.

The XG-PON standard, which is a standard for 10G passive optical network of the ITU-T, prefers to define that the downstream FEC should be always applied to the downstream and cannot be changed and the upstream FEC may be set for each upstream burst of each ONU, like the GPON standard, since it places more weight on services for residence subscribers and preferentially supports the worst optical link budget.

It is preferable to set whether to apply the downstream FEC when there is no effect obtained from the downstream FEC since the optical power budget in the passive optical network section is sufficient or when a downstream bandwidth requirement in the passive optical network section can still be satisfied after reducing the downstream FEC overhead (for XG-PON, approximately 13%, 1.28 GB/s).

In particular, services for business subscribers generally have a short link, such that the services may attach importance to requirements for the bandwidth relatively to requirements for the optical power budget.

The FEC is not applied when the number of subscribers is small in establishment of the passive optical network.

But a situation may occur in which increasing an effective optical power budget of a link is more important than partially decreasing the bandwidth when a link budget or noise environment is deteriorated due to the sudden increase in the number of subscribers.

FIG. 1 is a conceptual diagram showing generation of a traffic loss when a downstream FEC setting is changed in a passive optical network according to the related art. When the downstream FEC setting is desired to be changed from an “in-service” state corresponding to change in an optical link situation or change in a service bandwidth requirement, or when the downstream bandwidth needs to be increased by changing the downstream FEC setting without changing an operation state of an ONU, a method using the FEC identifier used in the GPON changes the FEC setting of the ONU if an FEC bit is changed and received four consecutive times in consideration of a data reception error of the ONU, such that a timing for changing the FEC setting of the OLT may be different from that of the ONU and also timings for changing the FEC setting may be different between the ONUs. Thus, this leads to a temporary loss of the downstream traffic.

### SUMMARY

Accordingly, the present invention provides a system and method for setting whether to use a forward error correction code for a downstream frame transmitted from an optical line terminal to an optical network unit in a time division multiplexing passive optical network.

In one general aspect, a system for setting a downstream forward error correction code in a time division multiplexing passive optical network, the system includes: an optical line terminal configured to change a downstream forward error correction (FEC) indication included in a downstream frame and set a downstream FEC indication counter included in the downstream frame to transmit the downstream frame; and an optical network unit configured to receive the downstream frame from the optical line terminal, detect the downstream FEC indication and the downstream FEC indication counter included in the downstream frame, and synchronize FEC setting change of the optical network unit with FEC setting change of the optical line terminal.

In another general aspect, a method of setting a forward error correction code in a time division multiplexing pass optical network, the method includes: receiving a downstream frame including a downstream FEC indication and a downstream FEC indication counter; detecting the downstream FEC indication and downstream FEC indication counter from a header of the received downstream frame to store the detected downstream FEC indication and downstream FEC indication counter; and while receiving following frames after the downstream frame, sequentially increasing the downstream FEC indication counter, and applying the downstream FEC setting according to the sequentially increased downstream FEC indication counter.

Other features and aspects will be apparent from the following detailed description, the drawings, and the claims.

### BRIEF DESCRIPTION OF THE DRAWINGS

FIG. 1 is a conceptual diagram showing generation of a traffic loss when downstream FEC setting of a passive optical network is changed according to the related art.

FIG. 2 is a block diagram showing a configuration of a passive optical network according to an embodiment of the present invention.

FIG. 3 is a conceptual diagram showing change of downstream FEC settings of the optical line terminal and the optical network unit by applying the downstream FEC setting according to an embodiment of the present invention.

FIG. 4 is a conceptual diagram showing a configuration in which a downstream FEC indication and a downstream FEC indication counter used in a system and method for setting a downstream forward error correction code in a time division multiplexing passive optical network is applied to a PON-ID structure in an XG-PON standard according to an embodiment of the present invention.

FIG. 5 is a flowchart showing a method of changing a downstream FEC setting according to an embodiment of the present invention.

FIGS. 6A and 6B are flowcharts showing a method of changing a downstream FEC setting using a downstream FEC indication and a downstream FEC indication counter of an optical network unit according to an embodiment of the present invention.

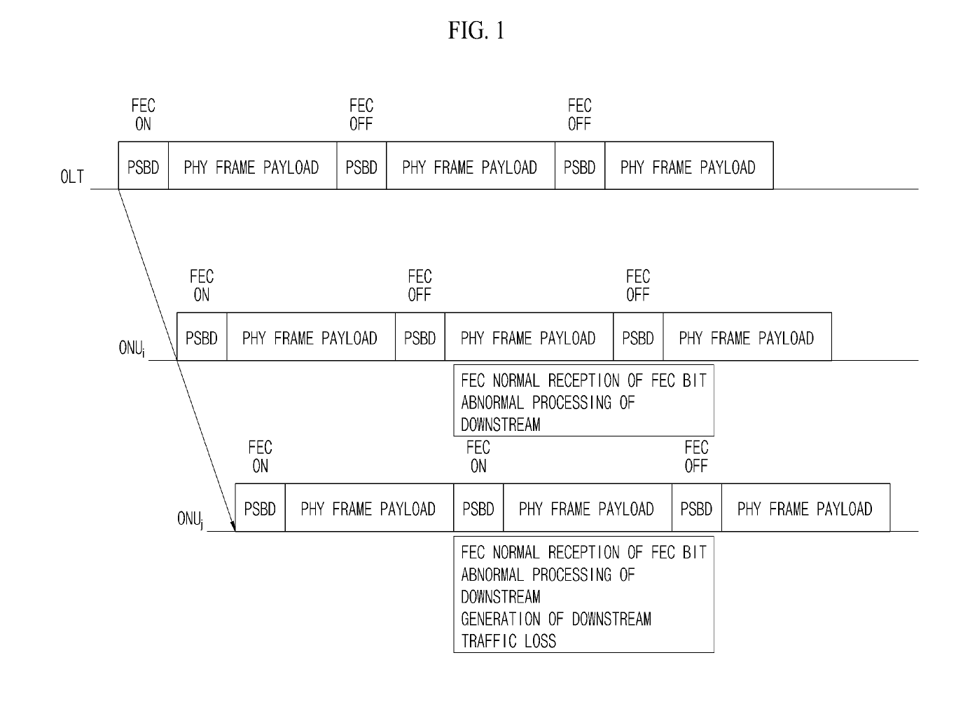

### DETAILED DESCRIPTION OF EMBODIMENTS

Hereinafter, exemplary embodiments will be described with reference to the accompanying drawings.

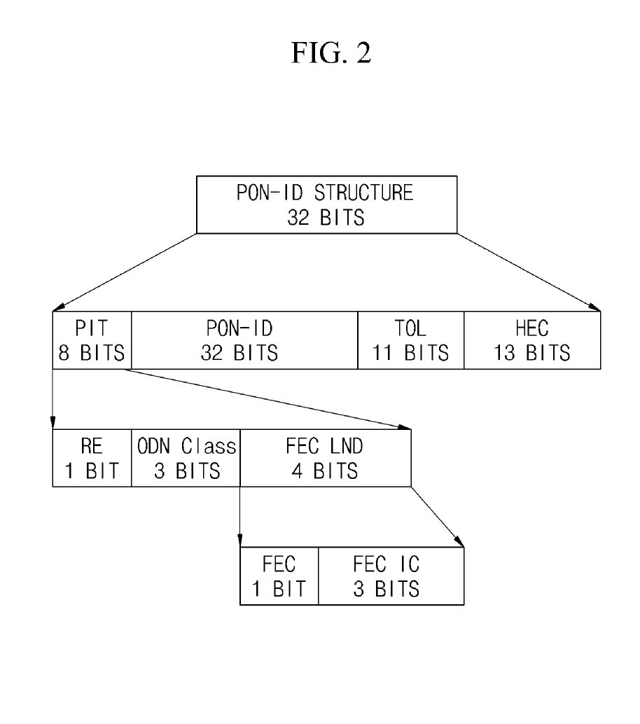

FIG. 2 is a conceptual diagram showing a configuration in which a downstream FEC indication and a downstream FEC indication counter used in a system and method for setting a downstream forward error correction code in a time division multiplexing passive optical network is applied to a PON-ID structure in an XG-PON standard. According to an embodiment of the present invention, the downstream FEC indication has one bit in size, and the downstream FEC indication counter has three bits in size.

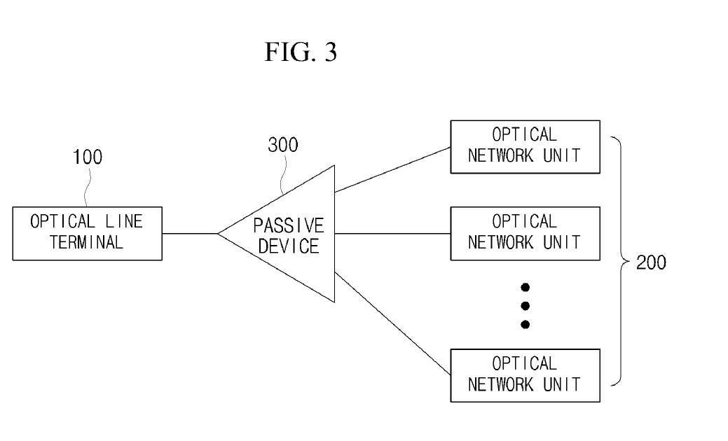

The downstream FEC indication serves as an FEC identifier used in the GPON standard and indicates whether to apply FEC to each frame. The FEC shown in FIG. 3 means the downstream FEC indication, ‘1’ means ‘on,’ ‘0’ means ‘off,’ and its default value is ‘1.’

FEC IC shown in FIG. 2 means the downstream FEC indication counter, and its default value is ‘000.’

Only when the downstream FEC indication is ‘000’ or ‘100,’ the optical line terminal 100 sets an FEC setting of the frame according to the downstream FEC indication. When the downstream FEC indication counter is one of ‘001’ to ‘011,’ the optical line terminal 100 maintains an existing FEC setting unchanged.

The downstream FEC indication counter of ‘000’ includes normal state information, and the downstream FEC indication counters of ‘001’ to ‘011’ indicate a downstream FEC indication change section and indicates that the downstream FEC indication has been changed and the changed indication is included in the N-th frame (N is 1, 2, or 3, that is, 001, 010, or 011 as a binary number) and transmitted.

In addition, the downstream FEC indication counter of ‘100’ is the last frame of the downstream FEC indication change section, which indicates that the downstream FEC indication is changed and a current frame is a fourth frame after the changed indicator is transmitted. The optical network unit 200 changes the downstream FEC setting according to the information of the changed indication from a frame having the downstream FEC indication counter of ‘100.’

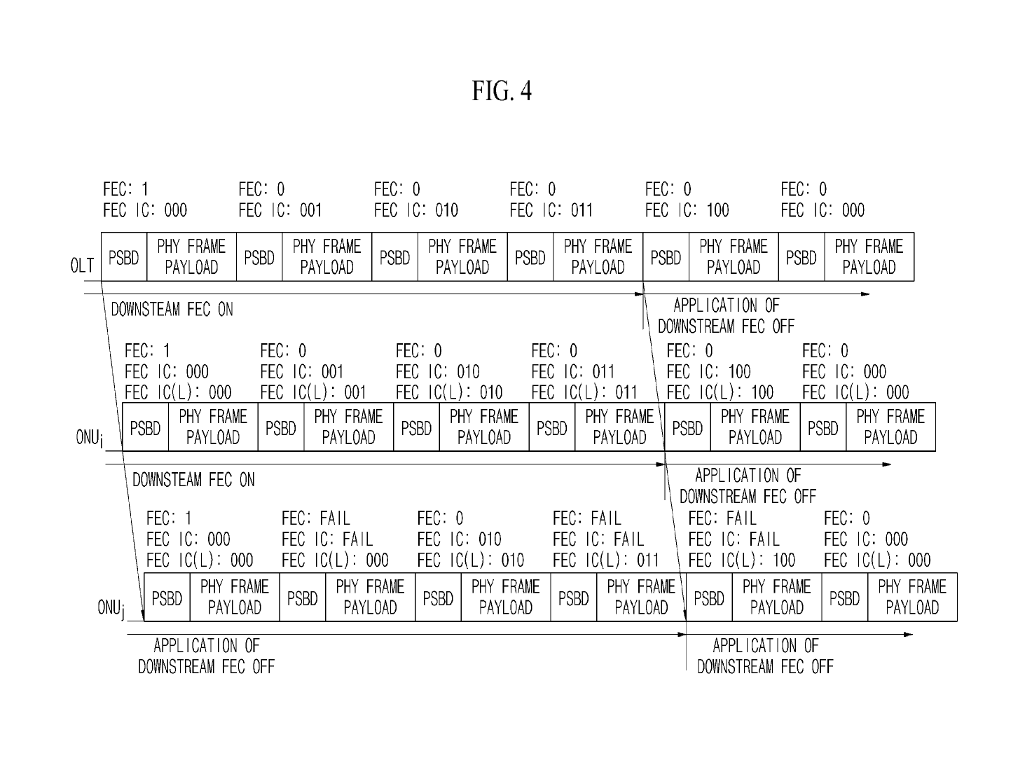

FIG. 3 is a block diagram showing a system for setting a downstream forward error correction code in a time division multiplexing passive optical network according to an aspect of the present invention, and FIG. 4 is a conceptual diagram showing change of the downstream FEC setting of the optical line terminal (OLT; 100) and the optical network unit (ONU; 200) by applying the downstream FEC setting according to an embodiment of the present invention.

As shown in FIGS. 3 and 4, the system for setting a downstream forward error correction code in a time division multiplexing passive optical network according to an aspect of the present invention includes an optical line terminal 100 configured to change a downstream forward error correction (FEC) indication included in a downstream frame and set a downstream FEC indication counter included in the downstream frame to transmit the downstream frame and an optical network unit 200 configured to receive the downstream frame from the optical line terminal 100 and synchronize an FEC setting thereof with an FEC setting of the optical line terminal 100 as a result of detection of the downstream FEC indication and downstream FEC indication counter included in the downstream frame.

The optical line terminal 100 according to an embodiment of the present invention receives a downstream FEC setting change request signal, changes a downstream FEC indication of a downstream frame according to the downstream FEC setting change request signal, and indicates whether to apply FEC to the downstream frame.

The optical line terminal 100 sets a frame after the downstream frame such that the downstream FEC indication counter may increase sequentially (for example, increase by 1).

The optical line terminal 100 does not change the downstream FEC setting when the downstream FEC indication counter of a frame after the downstream frame is less than a predetermined value of 4, changes the downstream FEC indication counter when the downstream FEC indication counter of a frame after the downstream frame is greater than or equal to the predetermined value of 4, and initializes and sets the downstream FEC indication counter to an initial value of 0 when the downstream FEC indication counter of a frame after the downstream frame is greater than the predetermined value of 4.

When the FEC indication of the downstream frame is ‘1,’ the optical line terminal 100 applies FEC to the downstream frame to insert a parity bit into the downstream frame and then encode the downstream frame. When the FEC indication of the downstream frame is ‘0,’ the optical line terminal 100 does not FEC-encode the downstream frame any more to transmit the downstream frame to the optical network unit 200.

The optical network unit 200 according to an embodiment of the present invention detects a header of the downstream frame and extract a downstream FEC indication and a downstream FEC indication counter from the detected header.

When extracting the downstream FEC indication and the downstream FEC indication counter, the optical network unit 200 determines whether to generate an uncorrectable error, and if an error having a predetermined number or more of bits is generated, determines that the uncorrectable error is generated.

As shown in FIG. 2, the PON-ID structure includes an HEC code of 13 bits. Thus the PON-ID structure can correct an error of two bits, but cannot perform correction with the HEC code when an error of three bits is generated. In this case, the optical network unit 200 determines that the uncorrectable error is generated.

When it is determined that the uncorrectable error is generated, the optical network unit 200 determines whether the local downstream FEC indication counter is an initial value of 0. When the local downstream FEC indication counter is the initial value, the optical network unit 200 maintains the pre-stored local downstream FEC indication, local downstream FEC indication counter, and the FEC setting for the downstream frame unchanged unchanged, and detects the downstream FEC indication and the downstream FEC indication counter from a header of a next physical layer (PHY) frame.

When it is determined that the uncorrectable error is generated, the optical network unit 200 determines whether the local downstream FEC indication counter is an initial value of 0. When the local downstream FEC indication counter is not the initial value, the optical network unit 200 maintains the pre-stored local downstream FEC indication, increases the pre-stored local downstream FEC indication counter, and stores the increased local downstream FEC indication counter.

When it is determined that the uncorrectable error is not generated, the optical network unit 200 determines whether the downstream FEC indication counter is an initial value of 0. When the downstream FEC indication counter is the initial value, the optical network unit 200 maintains the local downstream FEC indication, local downstream FEC indication counter and the FEC setting for the downstream frame unchanged, and detects the downstream FEC indication and the downstream FEC indication counter from a header of a next physical layer (PHY) frame.

When it is determined that the uncorrectable error is not generated, the optical network unit 200 determines whether the downstream FEC indication counter is an initial value of 0. When the downstream FEC indication counter does not have the initial value, the optical network unit 200 copies and stores the transmitted downstream FEC indication and downstream FEC indication counter to the local downstream FEC indication and local downstream FEC indication counter and stores of the optical network unit 200.

The optical network unit 200 determines whether the copied and stored local downstream FEC indication counter is a predetermined value of 4, and changes the FEC setting according to the local downstream FEC indication if the copied and stored local downstream FEC indication counter is the predetermined value and detects a header of the next physical layer frame if the copied and stored local downstream FEC indication counter does not have the predetermined value.

The optical network unit 200 changes the FEC setting and then resets the local downstream FEC indication counter to an initial value of 0.

FIG. 4 is a conceptual diagram showing change of a downstream FEC setting of an optical line terminal 100 and an optical network unit 200 by applying the downstream FEC setting according to an embodiment of the present invention. As shown in FIG. 4, the optical network unit 200 stores the normally received FEC indication counter therein and increase sequentially every frame.

Accordingly, even when a fourth downstream FEC indication counter is not normally received, the optical network unit 200 may easily determine whether the frame leads to change of the downstream FEC setting.

Although only one of the downstream FEC indication counters during four frames of 001 to 100 as binary numbers is normally received, if the downstream FEC indication counter is received without the uncorrectable error, the optical network unit 200 enables the downstream FEC setting synchronized with the optical line terminal 100 and therefore a synchronized change of the downstream FEC settings of the optical line terminal 100 and all the optical network units 200 connected therewith can be achieved.

As shown in FIG. 4, the optical network unit 200 may perform synchronization with the FEC setting of the optical line terminal 100 although the optical network unit 200 receives only one downstream FEC indication and downstream FEC indication counter in the frames of 001 to 100.

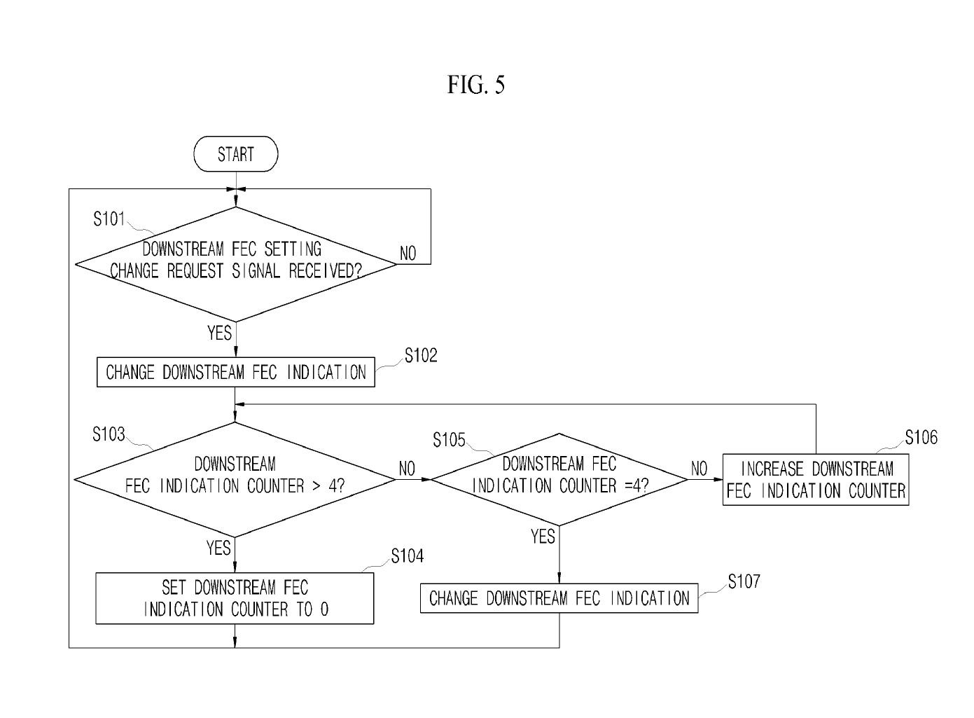

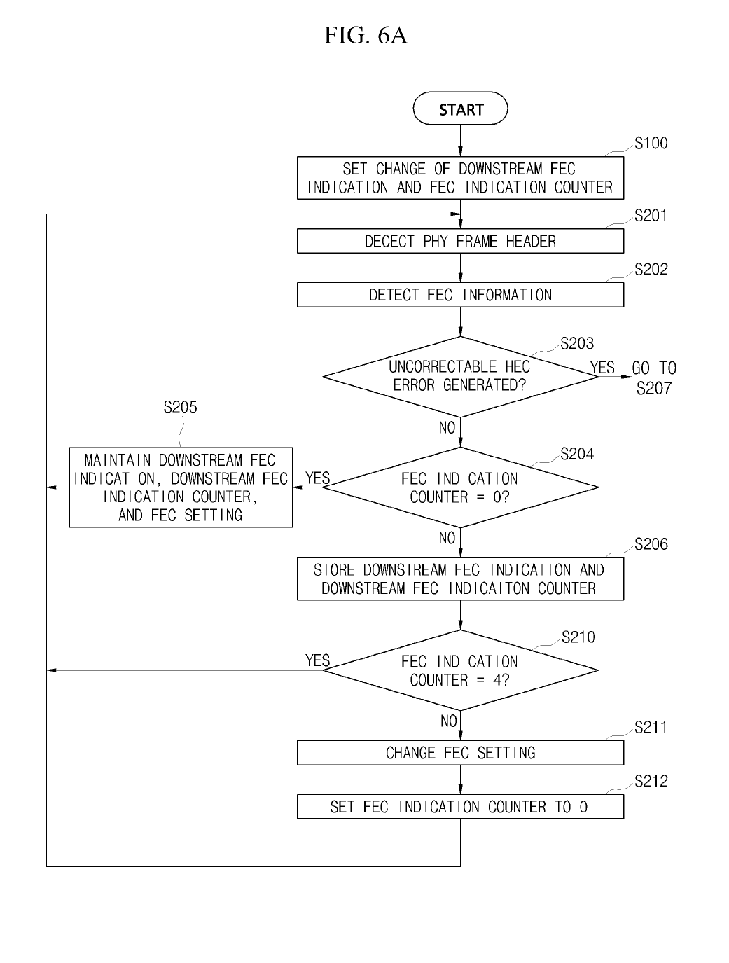

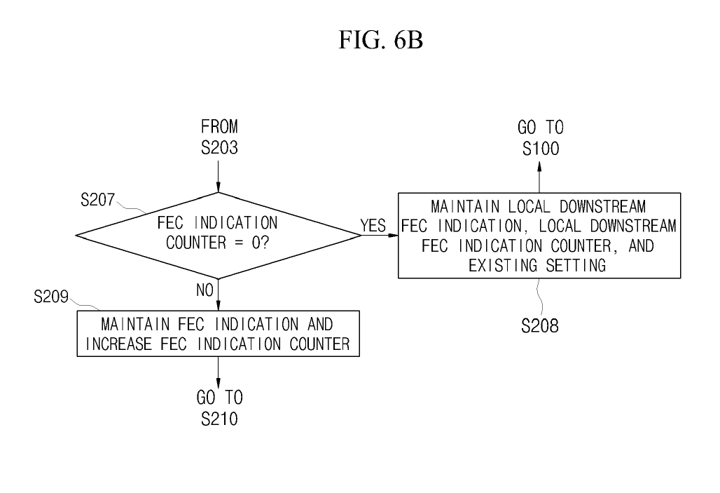

FIG. 5, FIG. 6A and FIG. 6B are flowcharts showing a method of changing a downstream FEC setting using a downstream FEC indication and a downstream FEC indication counter of a method for setting a forward error correction code in a time division multiplexing passive optical network according to another aspect of the present invention. Specifically, FIG. 5 is a flowchart showing a method of the optical line terminal 100 changing the downstream FEC setting using the downstream FEC indication and the downstream FEC indication counter, and FIGS. 6A and 6B are flowcharts showing a method of the optical network unit 200 changing the downstream FEC setting using the downstream FEC indication and the downstream FEC indication counter.

The method procedure determining whether a request to change the downstream FEC setting is received from an operator or a separate process for deciding the change of the downstream FEC setting in step S101, changing the downstream FEC indication included in the downstream frame according to the change request when a signal for requesting to change the downstream FEC setting is received in step S102, and setting the downstream FEC indication counter to increase by 1 every frame in step S106.

The procedure does not apply the change of the downstream FEC setting to the downstream frame when the downstream FEC indication counter is less than a predetermined value of 4, that is, 100 as a binary number, but changes the downstream FEC setting from the frame having the downstream FEC indication counter of 4 to apply the change to the frame in step S107.

That is, an encoding process for applying FEC to the downstream frame to insert parity bytes when the downstream FEC indication is ‘1 (on)’ while the previously encoded downstream frame is transmitted without any further FEC encoding when the downstream FEC indication is ‘0 (off).’

The procedure sets the downstream FEC indication counter to an initial value of 0 when the downstream FEC indication counter is greater than the predetermined value of 4 in step S104 and increases the downstream FEC indication counter by 1 when the downstream FEC indication counter is less than the predetermined vale of 4 in step S106.

As shown in FIGS. 6A and 6B, the optical network unit 200 recognizes a boundary of a physical layer frame using a synchronization pattern of the downstream physical layer (PHY) frame transmitted from the optical line terminal 100 to detect a header of the physical layer frame using the recognized boundary in step S210 and extracts the downstream FEC indication and downstream FEC indication counter positioned in the header to detect the FEC information in S202.

In the processing of detecting FEC information, the optical network unit 200 determines whether an uncorrectable error has been generated (for example, an error of three or more bits has been generated in the PON-ID structure shown in FIG. 3) in step S203.

In a case in which the uncorrectable error is not generated, the optical network unit 200 determines whether the downstream FEC indication counter is an initial value of 0 in step S204, and when the downstream FEC indication counter is an initial value, maintains the local downstream FEC indication, the local downstream FEC indication counter, and the FEC setting unchanged in step S205 to return to the step S210 for detecting a header of the next frame in step S201.

The optical network unit 200 determines that the uncorrectable error is not generated, and when the downstream FEC indication counter does not have an initial value of 0, copies and stores the downstream FEC indication and the downstream FEC indication counter of the received downstream frame in step S206 and determines whether the local downstream FEC indication counter is a predetermined value of 4 in step S210.

In this case, when the local downstream FEC indication counter is a predetermined value of 4, the optical network unit 200 changes the downstream FEC setting according to the local downstream FEC indication in step S211 and resets the local downstream FEC indication counter to an initial value of 0 in step S212.

However, in a case in which the uncorrectable error is generated, the optical network unit 200 determines whether the local downstream FEC indication counter is an initial value of 0 in step S207, and when the local downstream FEC indication counter is an initial value of 0, maintains the local downstream FEC indication, the local downstream FEC indication counter, and the FEC setting unchanged in step S208 and then returns to the step S201 for detecting the FEC information in the header of the next frame, and when the local downstream FEC indication counter does not have an initial value of 0, maintains the previously stored local downstream FEC indication unchanged, increases the previously stored local downstream FEC indication counter by 1, and then stores the increased stored local downstream FEC indication counter in step S209.

In the system and method for setting a downstream forward error correction code in a time division multiplexing passive optical network according to an embodiment of the present invention, it is possible to change the FEC setting without a loss of the downstream traffic by synchronizing the change of the FEC setting of the optical line terminal with the change of the FEC setting of the optical network unit.

Furthermore, although the optical network unit receives only one downstream FEC indication counter of a predetermined number of downstream frames, it is possible to perform synchronization with the change in the FEC setting of the optical line terminal to prevent a loss of the downstream traffic.

The effect of the present invention is not limited to the aforesaid, but other effects not described herein will be clearly understood by those skilled in the art from descriptions below.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for setting a downstream forward error correction code in a time division multiplexing passive optical network, the system comprising:
an optical line terminal configured to change a downstream forward error correction (FEC) indication included in a downstream frame and set a downstream FEC indication counter included in the downstream frame to transmit the downstream frame; and
an optical network unit configured to receive the downstream frame from the optical line terminal and synchronize an FEC setting of the optical network unit with the FEC setting of the optical line terminal as a result of detection of the downstream FEC indication and downstream FEC indication counter included in the downstream frame.

2. The system of claim 1, wherein the optical line terminal receives a downstream FEC setting change request signal, changes a downstream FEC indication of a downstream frame according to the downstream FEC setting change request signal, and indicates whether to apply FEC to the downstream frame.

3. The system of claim 1, wherein the optical line terminal sets a downstream FEC indication counter of a frame after the downstream frame to increase sequentially.

4. The system of claim 3, wherein the optical line terminal does not apply the change of the downstream FEC setting when the downstream FEC indication counter of the frame after the downstream frame is less than a predetermined value, changes the downstream FEC setting when the downstream FEC indication counter of the frame after the downstream frame is equal to or greater than the predetermined value, and initializes the downstream FEC indication counter of the frame after the downstream frame when the downstream FEC indication counter of the frame after the downstream frame is greater than the predetermined value.

5. The system of claim 4, wherein the optical line terminal encodes the downstream frame by applying an FEC code according to the downstream FEC indication of the downstream frame and transmits the encoded downstream frame to the optical network unit.

6. The system of claim 4, wherein the optical network unit detects a header of the received downstream frame, extracts a downstream FEC indication and downstream FEC indication counter in the detected header, and determines whether an uncorrectable error is generated.

7. The system of claim 6, wherein the optical network unit determines that the uncorrectable error is generated when an error of a predetermined number or more of bits is generated.

8. The system of claim 6, wherein in a case in which it is determined that the uncorrectable error is generated, the optical network unit determines whether the local downstream FEC indication counter is an initial value, and when the local downstream FEC indication counter is the initial value, maintains a previously stored local downstream FEC indication, local downstream FEC indication counter, and FEC setting unchanged and detects a header of a next frame.

9. The system of claim 8, wherein when the local downstream FEC indication counter does not have the initial value, the optical network unit maintains the previously stored local downstream FEC indication, increases a value of the previously stored local downstream FEC indication counter, and stores the increased local downstream FEC indication counter.

10. The system of claim 6, wherein in a case in which it is determined that the uncorrectable error is not generated, the optical network unit determines whether the downstream FEC indication counter is an initial value, and when the downstream FEC indication counter is the initial value, maintains a previously stored local downstream FEC indication, local downstream FEC indication counter, and FEC setting unchanged and detects a header of a next frame.

11. The system of claim 10, wherein when the downstream FEC indication counter does not have the initial value, the optical network unit stores the transmitted downstream FEC indication and downstream FEC indication counter.

12. The system of claim 11, wherein the optical network unit determines whether the stored downstream FEC indication counter is a predetermined value, and when the stored downstream FEC indication counter is the predetermined value, the optical network unit changes an FEC setting according to the downstream FEC indication.

13. The system of claim 12, wherein when the downstream FEC indication is on, the optical network unit decodes the downstream frame by applying an FEC code thereto.

14. The system of claim 12, wherein the optical network unit changes the FEC setting and resets the downstream FEC indication counter to an initial value.

15. A method of setting a downstream forward error correction code in a time division multiplexing pass optical network, the method comprising:
receiving a downstream frame including a downstream FEC indication and a downstream FEC indication counter;
detecting the downstream FEC indication and downstream FEC indication counter from a header of the received downstream frame to store the detected downstream FEC indication and downstream FEC indication counter; and
receiving a frame after the downstream frame, sequentially increasing the downstream FEC indication counter, and applying the downstream FEC setting according to the sequentially increased downstream FEC indication counter.

16. The method of claim 15, wherein the receiving of a downstream frame including a downstream FEC indication and a downstream FEC indication counter comprises receiving the downstream frame including the downstream FEC indication changed according to a downstream FEC setting change request signal and the downstream FEC indication counter set to be sequentially increased.

17. The method of claim 15, wherein the detecting of the downstream FEC indication and downstream FEC indication counter from a header of the received downstream frame to store the detected downstream FEC indication and downstream FEC indication counter comprises detecting the downstream FEC indication and downstream FEC indication counter and when an error having a predetermined number or more of bits is generated, determining that uncorrectable error is generated, determines whether the local downstream FEC indication counter is an initial value, and when the local downstream FEC indication counter is the initial value, detecting FEC information from a header of a next frame without changing the local downstream FEC indication, the local downstream FEC indication counter and the FEC setting.

18. The method of claim 17, wherein the detecting of the downstream FEC indication and downstream FEC indication counter from a header of the received downstream frame to store the detected downstream FEC indication and downstream FEC indication counter comprises when the uncorrectable error is not generated, checking whether the downstream FEC indication counter has the initial value, and when the downstream FEC indication counter is not the initial value, copying and storing the downstream FEC indication and the downstream FEC indication counter of the received downstream frame.

19. The method of claim 18, wherein the applying of the downstream FEC setting comprises determining whether a local downstream FEC indication counter obtained by copying and storing the downstream FEC indication counter of the received downstream frame and changing the FEC setting according to the local downstream FEC indication when the local downstream FEC indication counter is a predetermined value.

20. The method of claim 19, wherein the applying of the downstream FEC setting comprises changing an FEC setting according to the local downstream FEC indication and resetting the local downstream FEC indication counter to an initial value.
